(19) United States
(12) Patent Application Publication
(10) Pub. No.: US 2011/0165359 A1
(43) Pub. Date: Jul. 7, 2011

(54) Polyamide, composition comprising such a polyamide and uses thereof

(76) Inventors: Guillaume Le, Colombelles (FR); Julien Jouanneau, Pont-Audemer (FR); Benjamin Saillard, Bernay (FR)

(21) Appl. No.: 13/002,793

(22) PCT Filed: Jul. 3, 2009
(86) PCT No.: PCT/FR09/51310

§ 371 Date: Mar. 22, 2011

(30) Foreign Application Priority Data
Jul. 7, 2008 (FR) 0854600

(51) Int. Cl. C08L 77/06; C08G 69/26; C08G 69/36; B32B 1/08

(52) U.S. Cl. 428/36.91; 528/347; 528/338; 528/324; 528/329.1; 525/432; 524/606; 428/36.9

(57) ABSTRACT

The invention relates to a polyamide comprising at least two units having the following general formula:

X.Y
where:
   X is an alkylaromatic diamine and
   Y is an aliphatic carboxylic diacid selected from dodecanedioic (C12) acid, tetradecanedioic (C14) acid, hexadecanedioic (C16) acid,
characterized in that the carboxylic diacid comprises organic carbon from a renewable source determined according to standard ASTM D6866

The invention also relates to a composition comprising this polyamide and the use of said polyamide and of such a composition.

The present invention relates to a polyamide, to its method of preparation and to its uses, in particular in the fabrication of miscellaneous objects, such as consumer goods like electrical, electronic or automotive equipment, surgical equipment, packing materials and even sports articles.

The invention also relates to a composition comprising such a polyamide and to the uses of said composition, particularly for the fabrication of all or part of the objects listed above.

Polyamides are known today that are obtained by polycondensation of alkylaromatic diamines and diacids. These polyamides are particularly advantageous, because they generally have good chemical, physicochemical, thermal and mechanical properties, such as, for example, good mechanical strength at high temperature, and good impermeability to oxygen.

Patent application US 2002-0142179 describes mixtures (i) of a condensation product of metaxylylenediamine with a diacid having 6 to 12 carbon atoms with (ii) a copolymer of ethylene and ethyl acrylate grafted by maleic anhydride. All the examples are based on MXD.6. Document EP 1350806 describes mixtures (i) of a condensation product of metaxylylenediamine with a diacid consisting of more than 70% of a diacid having 4 to 20 carbon atoms with (ii) a smectite. All the examples are based on MXD.6.

This polyamide obtained from such an alkylaromatic diamine is particularly advantageous in the field of packaging thanks to its good barrier properties. It is also advantageous for the automotive, electrical and electronics fields, because of its very good high temperature strength.

However, the environmental concerns of recent years argue in favor of the development of materials which meet the concerns of sustainable development as much as possible, in particular by limiting the procurement of raw materials produced by the petroleum industry for their fabrication.

It is therefore the object of the present invention to propose a polyamide having some of the properties mentioned above, such as good high temperature strength, and also low water absorption, while its structure comprises units issuing from renewable raw material.

Other features, aspects, subjects and advantages of the present invention will appear even more clearly from a reading of the description and the examples that follow.

In general, polyamides comprise at least two identical or distinct repetitive units, these units being formed from the two corresponding monomers, or comonomers. Polyamides are therefore prepared from two or more monomers, or comonomers, selected from an amino acid, a lactam and/or a carboxylic diacid and a diamine.

This object is achieved by a polyamide comprising at least two units and having the following general formula:

X.Y

where X is an alkylaromatic diamine, and

Y is an aliphatic carboxylic diacid selected from dodecanedioic (C12) acid, tetradecanedioic (C14) acid, hexadecanedioic (C16) acid,

characterized in that the carboxylic diacid comprises organic carbon from a renewable source, also called bioresourced carbon, determined according to standard ASTM D6866.

Thus, the polyamide of the invention may be a homopolyamide, when it only comprises identical X.Y units. The polyamide of the invention may also be a copolyamide, when it comprises at least two distinct X.Y units. In general, the copolyamides are denoted X.Y/Z, in order to distinguish the various comonomers. The polyamide of the invention is preferably a homopolyamide.

A renewable raw material is a natural, animal or vegetable resource, the stock of which can be recreated in a short period at human scale. In particular, this stock must be renewable as fast as it is consumed.

In general, polyamides are polymers whose durability is one of their essential features. Polyamides are generally used in applications for which the anticipated service life is at least about a decade.

When raw materials from a renewable source, such as vegetable oil, like palm oil for example, are used for the fabrication of these polyamides, one can consider that a certain amount of CO₂ initially taken from the atmosphere during photosynthesis, in the case of plants, is durably fixed in the material, thereby shielding it from the carbon cycle during at least the entire service life of the polyamide product.

On the contrary, polyamides of fossil origin do not capture atmospheric CO₂ during their service life (atmospheric CO₂ captured during photosynthesis for example). At the end of life (for example during incineration), they potentially release the CO₂ stored in the fossil resource (fossilized carbon), in a quantity of about 2.5 tonnes per tonne of polyamide.

When fossil raw materials are used to fabricate these polyamides, at the end of the life of the material, carbon produced from its preparation, since it is fossilized, is thus reinjected into the carbon cycle, over a time scale of several million years. In other words, this carbon is added to the cycle, causing an imbalance. These mechanisms thus contribute to the accumulation effect and hence exacerbate the greenhouse effect.

For the polyamides of the invention, the use of raw materials from a renewable source instead of raw materials from a fossil source helps to reduce by at least 44% the quantities of fossil CO₂ potentially emitted at the end of life, CO₂ originating from their carbon-containing structure.

Unlike the materials produced from fossil fuels, renewable raw materials contain ¹⁴C. All the samples of carbon taken from living organisms (animals or plants) are in fact a mixture of 3 isotopes: ¹²C (accounting for about 98.892%), ¹³C (about 1.108%) and ¹⁴C (traces: 1.2×10⁻¹⁰%). The ¹⁴C/¹²C ratio of living tissues is identical to that of the atmosphere. In the environment, ¹⁴C exists in two predominant forms: in inorganic form, i.e. as carbon dioxide (CO₂), and in organic form, that is carbon integrated in organic molecules.

In a living organism, the ¹⁴C/¹²C ratio is kept constant by the metabolism because the carbon is continuously exchanged with the external environment. Since the proportion of ¹⁴C in the atmosphere is constant, the same applies in the organism, as long as it is living, because it absorbs this ¹⁴C in the same way as the ambient ¹²C. The average ¹⁴C/¹²C ratio is 1.2×10⁻¹².

¹²C is stable, that is the number of atoms of ¹²C in a given sample is constant over time. ¹⁴C is radioactive (each gram of carbon of a living being contains sufficient ¹⁴C isotopes to produce 13.6 decays per minute) and the number of these atoms in a sample decreases over time (t) by the law:

n=no exp(−at),

where:
no is the original number of ¹⁴C (at the death of the creature, animal or plant),
n is the number of ¹⁴C atoms remaining after time t,
a is the decay constant (or radioactive constant); it is related to the half-life.

The half-life is the period after which any number of radioactive nuclei or unstable particles of a given species is reduced by half by decay; the half-life T₁₁₂ is related to the decay constant a by the formula aT_{1/2}=ln 2. The half-life of ¹⁴C is 5730 years.

Considering the half-life (T_{1/2}) of ¹⁴C, the ¹⁴C content is substantially constant from the extraction of the renewable raw materials, up to the fabrication of the polyamides of the invention, and even until the end of their use.

In consequence, the presence of ¹⁴C in a material, regardless of its amount, provides information on the source of its component molecules, namely that they are bioresourced, that is that they originate from renewable raw materials and not from fossil materials.

The polyamides of the invention preferably comprise at least 20% by weight of organic carbon (that is carbon integrated in organic molecules) that is bioresourced, i.e. originating from renewable raw materials, compared to the total weight of the carbon of the polyamide. This quantity can be certified by determining the ¹⁴C content by one of the methods described in standard ASTM D6866-06 (Standard Test Methods for Determining the Biobased Content of Natural Range Materials Using Radiocarbon and Isotope Ratio Mass Spectrometry Analysis). The document is incorporated by reference.

This standard ASTM D6866-06 comprises three methods for measuring organic carbon originating from renewable raw materials, referred to as biobased carbon. The proportions indicated for the polyamides of the invention are preferably measured by the mass spectrometry method or by the liquid scintillation spectrometry method described in this standard.

In consequence, the presence of ¹⁴C in a material, regardless of the quantity involved, provides information about the origin of the molecules making it up, that is that a certain fraction originates from renewable raw materials and no longer from fossil materials. The measurements taken by the methods described in standard ASTM D6866-06 thereby serve to distinguish the monomers or starting reactants issuing from renewable materials from the monomers or reactants issuing from fossil materials. These measurements have a test role.

Thus, by using the carboxylic diacid Y obtained from a renewable raw material, the polyamides obtained have mechanical, chemical and thermal properties similar to those of the prior art polyamides obtained from the same diacid that is produced by the petrochemical industry, and this meets at least one of the concerns for sustainable development mentioned above, that is the fact of limiting the use of fossil resources.

Raw materials of plant origin have the advantage of consisting of compounds essentially having even numbers of carbon atoms, contrary to the monomers from petroleum cuts, which have impurities comprising both even and odd numbers of carbon atoms.

The impurities drained during the processing of products originating from plant raw materials therefore essentially have an even number of carbon atoms.

On the contrary, the presence of impurities with an odd number of carbon atoms in monomers of fossil origin has a direct impact on the macromolecular structure of the final polyamide, giving rise to a disorganization of the structure. In consequence, some properties of the polyamide may be affected thereby, such as the crystallinity, melting point and glass transition temperature, for example.

The Y monomer of the polyamide is obtained from diacids originating from renewable raw materials, which are identified by standard ASTM D6866. The content expressed as a percentage of renewable or bioresourced organic carbon in the polyamide of the invention, denoted % C_{org.renew}, is strictly higher than 0, the content % C_{org.renew} satisfying the following equation (I):

$$\% {C}_{org . renew} = \frac{{\sum }_{i} Fi \times Ci + {\sum }_{k} Fk \times {Ck}^{′}}{( {\sum }_{j} Fj \times Cj + {\sum }_{i} Fi \times Ci + {\sum }_{k} Fk \times Ck )} \times 100 \qquad ( I )$$

where i=monomer(s) originating from 100% renewable raw materials,
j=monomer(s) originating from 100% fossil raw materials,
k=monomer(s) originating partly from renewable raw materials,
Fi, Fj, Fk=respective molar fraction(s) of the monomers i, j and k in the polyamide,
Ci, Cj, Ck=respective number (or respective weight) of carbon atoms of the monomers i, j and k in the polyamide,
Ck′=number (or respective weight) of renewable or bioresourced organic carbon atoms in the monomer(s) k,

the (renewable or fossil) nature, that is the origin of each of the monomers i, j and k being determined by one of the measurement methods of standard ASTM D6866.

The (co)monomers X and Y are monomers i, j and k in the sense of equation (I).

Preferably, the polyamide has a % C_{org.renew} content that is equal to or higher than 20%, advantageously equal to or higher than 50%, preferably equal to or higher than 55%, and more preferably equal to or higher than 60%.

In other words, the polyamide comprises at least 20% by weight (or number of atoms), preferably at least 50% by weight (or number of atoms), more particularly at least 55% by weight (or number of atoms), or even more preferably at least 60% by weight (or number of atoms) of carbon from a renewable source, compared to the total weight (or total number of atoms) of carbon of the polyamide.

When the polyamide of the invention has a % C_{org.renew} content equal to or higher than 25% and, in particular equal to or higher than 50%, it meets the requirements for obtaining JBPA “Biomass PLA” certification, which is also based on standard ASTM D6866. The polyamide of the invention may also validly have the “Biomass-based” label of the JORA Association.

For example, the (co)monomer(s) may originate from renewable resources, such as vegetable oils or natural polysaccharides such as starch or cellulose, the starch being extractable, for example, from corn or potato. This or these (co)monomer(s), or starting products, may in particular originate from various processing methods, in particular conventional chemical processes, and also processing by enzymatic methods or bio-fermentation.

The C12 diacid (dodecanedioic acid) can be obtained by bio-fermentation of dodecanedioic acid, also called lauric acid, and the lauric acid may be extracted from rich oil formed of palm kernel and coconut, for example.

The C14 diacid (tetradecanedioic acid) can be obtained by bio-fermentation of myristic acid, said myristic acid being extractable from rich oil formed of palm kernel and coconut, for example.

The C16 diacid (hexadecanedioic acid) can be obtained by bio-fermentation of palmitic acid, the latter mainly being present in palm oil, for example.

For example, it is possible to use the modified yeast Candida tropicalis to convert a monoacid to a diacid. Reference can also be made to documents WO 91/06660 and U.S. Pat. No. 4,474,882.

According to a first aspect of the invention, the polyamide is a homopolyamide having the formula X.Y described above.

More particularly, in the formula X.Y of the polyamide of the invention, X denotes the alkylaromatic diamine and Y denotes a linear aliphatic carboxylic diacid selected from dodecanedioic (C12) acid, tetradecanedioic (C14) acid and hexadecanedioic (C16) acid.

Preferably, the alkylaromatic diamine is selected from metaxylylenediamine (also called MXD or 1,3-xylylene diamine) and paraxylylenediamine (also called PXD or 1,4-xylylene diamine).

The preferred polyamides of the invention are homopolyamides having the following formula: MXD.12, MXD.14, MXD.16 and PXD.12.

The molar proportions of monomer X and monomer Y are preferably stoichiometric.

The homopolyamide of the invention may comprise Y monomers, that is dodecanedioic (C12) acid, tetradecanedioic (C14) acid or hexadecanedioic (C16) acid, originating from renewable resources, and optionally from fossil resources. Advantageously, the homopolyamide only comprises Y monomers from renewable resources determined according to standard ASTM D6866.

According to a second aspect of the invention, the polyamide is a copolyamide and may comprise at least two distinct units having the following general formula:

X.Y/Z

where: X and Y are as defined above, and

Z is selected from a unit obtained from an amino acid, a unit obtained from a lactam and a unit having the formula (Ca diamine).(Cb diacid), where a is the number of carbons of the diamine and b is the number of carbons of the diacid, a and b each being between 4 and 36.

The copolyamide of the invention may comprise Y monomers originating from renewable resources, and optionally from fossil resources. Advantageously, the Y monomers only comprise bioresourced carbon, that is of renewable origin determined according to the standard ASTM D6866.

When Z is an amino acid, it may be selected from 9-aminononanoic (Z=9) acid, 10-aminodecanoic (Z=10) acid, 12-aminododecanoic (Z=12) acid and 11-aminoundecanoic (Z=11) acid, and also its derivatives, in particular N-heptyl-11-aminoundecanoic acid.

Instead of an amino acid, a mixture of two, three or more amino acids may also be considered. However, the copolyamides formed would then comprise three, four or more units, respectively.

When Z is a lactam, it may be selected from pyrrolidinone, piperidinone, caprolactam (Z=6), enantholactam, caprylolactam, pelargolactam, decanolactam, undecanolactam, and lauryllactam (Z=12).

Among the feasible combinations, the following copolyamides are particularly advantageous: these are copolyamides having one of the formulas selected from MXD.12/11, MXD.12/12, MXD.12/6, MXD.14/11, MXD.14/12 and MXD.14/6.

In an advantageous version of the invention, the molar content of Z in the final copolyamide is between 0 (not inclusive) and 80% (inclusive), the molar content of alkylaromatic diamine X being between 50 (not inclusive) and 10% (inclusive) and the molar content of Y diacid being also between 50 (not inclusive) and 10% (inclusive).

When the Z unit is a unit having the formula (Ca diamine).(Cb diacid), the unit (Ca diamine) has the formula H₂N—(CH₂)ₐ—NH₂, when the diamine is aliphatic and linear.

Preferably, the Ca diamine is selected from butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecenediamine (a=18), eicosanediamine (a=20), docosanediamine (a=22) and diamines obtained from fatty acids.

When the diamine is cycloaliphatic, it is selected from bis(3,5-dialkyl-4-aminocyclohexyl)methane, bis(3,5-dialkyl-4-aminocyclohexypethane, bis(3,5-dialkyl-4-aminocyclo-hexyl)propane, bis(3,5-dialkyl-4-aminocyclo-hexyl)butane, bis-(3-methyl-4-aminocyclohexyl)-methane (BMACM or MACM), p-bis(aminocyclohexyl)-methane (PACM) and isopropylidenedi(cyclohexylamine) (PACP). It may also comprise the following carbon skeletons: norbornyl methane, cyclohexylmethane, dicyclohexylpropane, di(methylcyclohexyl), di(methylcyclohexyl) propane. An incomplete list of these cycloaliphatic diamines is given in the publication “Cycloaliphatic Amines” (Encyclopaedia of Chemical Technology, Kirk-Othmer, 4th Edition (1992), pp. 386-405).

When the diamine is alkylaromatic, it is selected from 1,3-xylylene diamine and 1,4-xylylene diamine.

When the monomer (Cb diacid) is aliphatic and linear, it is selected from succinic (y=4) acid, pentanedioic (y=5) acid, adipic (y=6) acid, heptanedioic (y=7) acid, octanedioic (y=8) acid, azelaic (y=9) acid, sebacic (y=10) acid, undecanedioic (y=11) acid, dodecanedioic (y=12) acid, brassylic (y=13) acid, tetradecanedioic (y=14) acid, hexadecanedioic (y=16) acid, octadecanedioic (y=18) acid, octadecenedioic (y=18) acid, eicosanedioic (y=20) acid, docosanedioic (y=22) acid and dimers of fatty acids containing 36 carbons.

When the monomer (Cb diacid) is dodecanedioic (y=12) acid, tetradecanedioic (y=14) acid or hexadecanedioic (y=16) acid, it may be of renewable origin and/or fossil origin.

The fatty acid dimers mentioned above are dimerized fatty acids obtained by oligomerization or polymerization of unsaturated monobasic fatty acids with a long hydrocarbon chain (such as linoleic acid and oleic acid), as described in particular in document EP 0 471 566.

When the diacid is cycloaliphatic, it may comprise the following carbon skeletons: norbornyl methane, cyclohexylmethane, dicyclohexylmethane, dicyclohexylpropane, di(methylcyclohexyl), di(methylcyclohexyl)propane.

When the diacid is aromatic, it is selected from terephthalic acid (denoted T), isophthalic acid (denoted I) and naphthalenic diacids.

Obviously, the particular case in which the unit (Ca diamine).(Cb diacid) is strictly identical to the unit X.Y is excluded, the Ca diamine being the same alkylaromatic diamine as X and the Cb diacid being the same diacid as the Y diacid, whether the latter is of renewable origin determined according to standard ASTM D6866 and/or of fossil origin. In fact, in this particular eventuality, the same homopolyamide is involved as the one already considered in the first aspect of the invention.

Among all possible combinations for the copolyamides X.Y/Z where Z is a unit (Ca diamine).(Cb diacid), the copolyamides selected are particularly those having one of the formulas selected from MXD.12/PXD.12, MXD.14/PXD.14, MXD.12/6.12, MXD.12/10.12, MXD.12/12.12, MXD.12/MXD.6, MXD.12/MXD.10, MXD.12/10.10 and MXD.12/6.10.

The nomenclature used to define the polyamides is described in standard ISO 1874-1:1992, “Plastiques—Matériaux polymides (PA) pour moulage et extrusion—Partie 1: Désignation” [Plastics—Polyamides (PA) for moulding and extrusion—Part 1: Designation], particularly on page 3 (Tables 1 and 2) and is well known to a person skilled in the art.

According to another aspect of the invention, the copolyamide further comprises at least one third unit and has the following general formula:

X.Y/Z/A

where

A is selected from a unit obtained from an amino acid, a unit obtained from a lactam and a unit having the formula (Cd diamine).(Ce diacid), where d is the number of carbons of the diamine and e is the number of carbons of the diacid, d and e each being between 4 and 36.

In the formula X.Y/Z/A, reference can be made to what has already been described for the (co)monomers or X.Y units on the one hand, and Z on the other hand.

In this same formula, the A unit has the same meaning as the unit Z defined above. Obviously, the particular case in which the unit A is strictly identical to the unit Z is excluded.

Among all possible combinations for the copolyamides X.Y/Z/A, the copolyamides particularly selected are those having one of the formulas selected from MXD.12/6/6.12, MXD.12/11/6.12, MXD.12/12/6.12, MXD.12/6/10.12, MXD.12/11/10.12, MXD.12/12/10.12, MXD.12/6/MXD.6, MXD.12/11/MXD.6, MXD.12/12/MXD.6, MXD.12/6/MXD.10, MXD.12/11/MXD.10, MXD.12/12/MXD.10, MXD.12/6/12.12, MXD.12/11/12.12 and MXD.12/12/12.12.

The Z and A units may originate from fossil resources or may be bioresourced, that is originate from renewable resources, thereby increasing, in the latter case, the proportion of organic carbon in the final copolyamide.

The invention also relates to a method for preparing a polyamide as defined above, comprising at least one step of polycondensation of at least one aliphatic carboxylic diacid selected from dodecanedioic (C12) acid, tetradecanedioic (C14) acid, hexadecanedioic (C16) acid comprising bioresourced carbon, that is from a renewable source, that is bioresourced on an alkylaromatic diamine.

The above preparation method may be supplemented by two steps preceding the abovementioned polycondensation step:

a) obtaining a fatty monoacid from a renewable raw material, such as for example vegetable or animal oils; optionally purification,

b) preparation of a diacid from the fatty monoacid issuing from the preceding step, as for example by fermentation;

said diacid then being polycondensed on an alkylaromatic diamine.

The invention also relates to a composition comprising at least one polyamide according to the invention.

A composition according to the invention may further comprise at least one second polymer.

Advantageously, said second polymer may be selected from a semicrystalline polyamide, an amorphous polyamide, a semicrystalline copolyamide, an amorphous copolyamide, a polyether amide, a polyester amide and mixtures thereof.

Said second polymer is preferably obtained from a renewable raw material, that is passing the test of standard ASTM D6866.

Said second polymer may in particular be selected from starch, which may be modified and/or formulated, cellulose or its derivatives such as cellulose acetate or cellulose ethers, polylactic acid, polyglycolic acid and polyhydroxyalkanoate.

The composition of the invention may also further comprise at least one additive.

Said additive may in particular be selected from fillers, fibers, dyes, stabilizers, in particular UV stabilizers, plasticizers, shock modifying agents, surfactants, pigments, bluing agents, antioxidants, natural waxes and mixtures thereof.

Among fillers, mention may be made in particular of silica, carbon black, carbon nanotubes, expanded graphite, titanium oxide or even glass beads.

Preferably, this additive is of natural and renewable origin, that is passing the test of standard ASTM D6866.

If, with the exception of N-heptyl-11-aminoundecanoic acid, fatty acid dimers and cycloaliphatic diamines, the comonomers or starting products considered in the present description (amino acids, diamines, diacids) are effectively linear, it is perfectly conceivable for all or some of them to be branched, such as 2-methyl-1,5-diaminopentane, partially unsaturated.

It should be observed in particular that the C18 carboxylic diacid may be octadecanedioic acid, which is saturated, or even octadecenedioic acid, which has an unsaturation.

The polyamide of the invention or the composition of the invention may be used to form a structure.

Said structure may be a monolayer structure if formed only of the polyamide or of the composition of the invention.

Said structure may also be a multilayer structure, if it comprises at least two layers, and if at least one of the various layers forming the structure is formed of the polyamide or of the composition of the invention.

The structure, whether monolayer or multilayer, may in particular be in the form of fibers, a film, a tube, a hollow body, an injected part.

The use of the polyamide or of the composition of the invention may also be considered for all or part of elements of electrical and electronic equipment such as telephone, computer, multimedia systems.

The polyamides and compositions of the invention may be fabricated by the usual methods described in the prior art. Reference can be made in particular to document DE 4318047 or U.S. Pat. No. 6,143,862.

The present invention will now be described in the examples below, such examples being provided only for illustration, and obviously nonlimiting.

Preparation of Various Polyamides and Copolyamides (Tests A to H)

The monomers used in all or part of tests A to H are the following:
metaxylylenediamine (denoted MXD in the table) supplied by DKSH, CAS 1477-55-0

paraxylylenediamine (denoted PXD in the table) supplied by Aldrich, CAS 539-48-0

dodecanedioic acid (denoted DC12 in the table) originating from the renewable resource supplied by Cathay Biotechnology, CAS 693-23-2

tetradecanedioic acid (denoted DC14 in the table) originating from the renewable resource supplied by Cathay Biotechnology, CAS 821-38-5

sebacic acid (denoted DC10 in the table) supplied by Sun Chemie, CAS 111-20-6

decanediamine (denoted DA10 in the table), supplied by Sun Chemie, CAS 646-25-3

caprolactam (denoted L6 in the table), supplied by BASF, CAS 105-60-2

11-aminoundecanoic acid (denoted A11 in the table) supplied by Arkema, CAS 2432-99-7

lauryllactam (denoted L12 in the table) supplied by Arkema, CAS 947-04-6.

Various homopolyamides and copolyamides were prepared from several monomers according to the particular compositions (Examples A to H) given in the table below.

The preparation method, transposable for all the Examples A to H, will now be described in detail for Example A (synthesis of MXD.12):

The following monomers are introduced into a reactor equipped with a stirrer: 14.1 kg (103.5 mol) metaxylylenediamine, 23.8 kg (103.5 mol) dodecanedioic acid and 500 g H₂O. The mixture thus formed is placed under inert atmosphere and heated to 240° C. and a maximum of 30 bar pressure. After holding for 1 h, the mixture is expanded for 2 h to return to atmospheric pressure. The polycondensation is continued for about 2 h at 275° C. with nitrogen flushing until the polymer reaches the desired viscosity.

| | | | | | | | | | | % (w) |
|---|---|---|---|---|---|---|---|---|---|---|
| | | | | | | | | | | renewable |
| | MXD | PXD | DC12 | DC14 | DC10 | DA10 | L6 | A11 | L12 | C (ASTM |
| Examples | mol % | mol % | mol % | mol % | mol % | mol % | mol % | mol % | mol % | D6866) |
| A | 50 | 0 | 50 | 0 | 0 | 0 | 0 | 0 | 0 | 60.0 |
| B | 0 | 50 | 50 | 0 | 0 | 0 | 0 | 0 | 0 | 60.0 |
| C | 50 | 0 | 0 | 50 | 0 | 0 | 0 | 0 | 0 | 63.6 |
| D | 35 | 0 | 35 | 0 | 0 | 0 | 30 | 0 | 0 | 47.7 |
| E | 35 | 0 | 35 | 0 | 0 | 0 | 0 | 30 | 0 | 72.8 |
| F | 35 | 0 | 35 | 0 | 0 | 0 | 0 | 0 | 30 | 39.6 |
| G | 40 | 0 | 50 | 0 | 0 | 10 | 0 | 0 | 0 | 68.6 |
| H | 50 | 0 | 25 | 0 | 25 | 0 | 0 | 0 | 0 | 57.9 |

2. Comparison of Proportions of Impurities Present in the Samples of Diacids of Fossil and Plant Origin

Samples of the following diacids where analyzed:
a dodecanedioic acid from a renewable source or bioresourced, prepared by the following method:

Lauric acid can be extracted from coconut oil or from palm kernel oil. A dodecanedioic acid can then be obtained by bio-fermentation from lauric acid, using the appropriate microorganism. The diacid can then be aminated in the presence of ammonia and at least one strong base, without solvent.
a dodecanedioic acid of fossil origin,
a tetradecanedioic acid of renewable origin or bioresourced, prepared by the following method:

Myristic acid can be extracted from coconut oil or from palm kernel oil. A tetradecanedioic acid can then be obtained by bio-fermentation from myristic acid, using the appropriate microorganism. The diacid can then be aminated in the presence of ammonia and at least one strong base, without solvent.
a tetradecanedioic acid of fossil origin.

All these products were previously derived by silylation in a mixture of acetonitrile, trimethylamine and bis(trimethylsilyl)trifluoroacetamide.

Samples of each of the products obtained are analyzed semiquantitatively by mass spectrometry coupled gas chromatography.

The internal standard used is Tinuvin 770, and the column is of the CP-SIL 5CB type (Varian) with a length of 50 m.

This analysis serves to identify a certain number of impurities of the aliphatic diacid type, some containing an even number of carbon atoms and others an odd number, and to compare their mutual contents semiquantitatively.

Thus, for each of the samples analyzed, the following ratio R was calculated:

$$R = \frac{\begin{matrix}quantity of impurity containing an \\ odd number of carbon atoms\end{matrix}}{\begin{matrix}quantity of impurity containing an \\ even number of carbon atoms\end{matrix}}$$

The results are given in the table below:

TABLE 2

| | Source | R |
|---|---|---|
| dodecanedioic acid | fossil | 0.650 |
| | plant | 0.115 |
| tetradecanedioic acid | fossil | 0.175 |
| | plant | 0.098 |

These analyses show that the proportion of impurities containing an odd number of carbon atoms is much lower in the case of products of plant origin, thereby contributing to disturb to a lesser extent the macromolecular structure of the polyamides prepared from these products.

3. Evaluation of Atmospheric CO₂ Leaving the Carbon Cycle

The table below resumes the quantities of atmospheric CO₂ “removed” from the carbon cycle, when one tonne of polyamides of the invention is produced.

TABLE 3

| | MXD.12 | MXD.14 | MXD.16 |
|---|---|---|---|
| Atmospheric CO₂ | 1.6 tonnes | 1.72 tonnes | 1.82 tonnes |
| equivalent stored/ | | | |
| tonnes of PA | | | |

4. Evaluation of the Mass of CO₂ Potentially Released at the End of Life

The measurement is taken on MXD.12 having the raw repetition unit formula: C₂₀H₃₀N₂O₂, the molar weight of the repetition unit being 330 g/mol with a carbon C mass: 240 g/mol, or a total % C percentage=72.73%.

TABLE 4

| | | MXD.12 |
|---|---|---|
| | MXD.12 | partially |
| | 100% originating | bioresourced |
| | from fossil | according to |
| | resources | the invention |
| Renewable C %/total Cs | 0 | 60 |
| constituting the PA | | |
| Weight of non-neutral CO₂ (t) | 2.67 | 1.07 |
| issuing from the skeleton per | | |
| tonne of PA potentially released | | |
| at the end of life (incineration) | | |
| % decrease in fossil CO₂ released | 0 | 60 |
| during incineration | | |

1. A polyamide comprising at least two units having the following general formula:
X.Y
where:
X is an alkylaromatic diamine and
Y is an aliphatic carboxylic diacid selected from dodecanedioic (C12) acid, tetradecanedioic (C14) acid, hexadecanedioic (C16) acid,
characterized in that the carboxylic diacid comprises organic carbon from a renewable source determined according to standard ASTM D6866.

2. The polyamide as claimed in claim 1, characterized in that the polyamide comprises at least 20% by weight, preferably at least 50% by weight, and more particularly at least 55% by weight of carbon from a renewable source compared to the total weight of the carbon of the polyamide.

3. The polyamide as claimed in claim 1, characterized in that the monomer X is selected from metaxylylenediamine and paraxylylenediamine.

4. The polyamide as claimed in claim 1, characterized in that the polyamide is a homopolyamide.

5. The polyamide as claimed in claim 1, characterized in that it has the formula MXD.12, MXD.14, MXD.16 and PXD.12, where MXD denotes metaxylylenediamine, PXD denotes paraxylylenediamine.

6. The polyamide as claimed in claim 1, characterized in that it is a copolyamide comprising at least two distinct units having the following general formula:
X.Y/Z
where:
X and Y are as defined in any one of the preceding claims,
Z is selected from a unit obtained from an amino acid, a unit obtained from a lactam and a unit having the formula (Ca diamine).(Cb diacid), where a is the number of carbons of the diamine and b is the number of carbons of the diacid, a and b each being between 4 and 36.

7. The polyamide as claimed in claim 6, characterized in that it is a copolyamide selected from copolyamides having the following formula: MXD.12/6, MXD.12/11, MXD.12/12, MXD.12/10.12, MXD.12/MXD.6, MXD.12/MXD.10, where MXD is metaxylylenediamine, PXD is paraxylylenediamine.

8. A method for preparing a polyamide as defined in claim 1, comprising at least one step of polycondensation of at least one aliphatic carboxylic diacid selected from dodecanedioic (C12) acid, tetradecanedioic (C14) acid, hexadecanedioic (C16) acid and comprising carbon from a renewable source determined according to standard ASTM D6866, on an alkylaromatic diamine.

9. A composition comprising at least one polyamide as claimed in claim 1.

10. The composition as claimed in claim 9, characterized in that it further comprises at least one second polymer selected from a semicrystalline or amorphous polyamide, a semicrystalline or amorphous copolyamide, a polyetheramide, a polyesteramide and mixtures thereof.

11. The composition as claimed in claim 9, characterized in that the second polymer is obtained from a renewable raw material determined according to standard ASTM D6866.

12. The composition as claimed in claim 9, characterized in that it further comprises at least one additive, preferably from a natural and renewable source determined according to standard ASTM D6866, said additive being selected from fillers, fibers, dyes, stabilizers, in particular UV stabilizers, plasticizers, shock modifying agents, surfactants, pigments, bluing agents, antioxidants, natural waxes and mixtures thereof.

13. In a monolayer structure or at least one layer of a multilayer structure comprising a polyamide, the improvement wherein the polyamide is one of claim 1.

14. The structure of claim 13, characterized in that the structure has the form of fibers, a film, a tube, a hollow body or an injected part.
